(19) United States
(12) Patent Application Publication
(10) Pub. No.: US 2017/0304919 A1
(43) Pub. Date: Oct. 26, 2017

(54) Device for Positioning a Thread in a Workpiece

(71) Applicant: Ehrt Maschinenbau GmbH, Rheinbreitbach (DE)

(72) Inventor: Andreas Winters, Rheinbreitbach (DE)

(21) Appl. No.: 15/520,494

(22) PCT Filed: Oct. 20, 2015
(86) PCT No.: PCT/EP2015/002077

§ 371 Date: Apr. 20, 2017

(30) Foreign Application Priority Data
Oct. 21, 2014 (DE) 10 2014 015 439.4
Apr. 30, 2015 (DE) 10 2015 005 486.4

(51) Int. Cl. B23G 1/46; B23G 1/32; B23G 3/00

(52) U.S. Cl. CPC B23G 1/46; B23G 3/005; B23G 1/32; B23G 2200/14

(57) ABSTRACT

A device (44) for forming a thread in a workpiece has a housing and a plurality of tool receptacles (2) rotatably and displaceably mounted in or on the housing for a respective thread-forming tool, wherein a linear drive and a rotary drive for the tool receptacles (2) are integrated into the housing.

The invention relates to a device for forming a thread in a workpiece having a housing and a plurality of tool receptacles which are rotatably and displaceably mounted within the housing for a respective thread-forming tool.

Such devices serve to generate threads in workpieces automatically. On one hand the threads can be cut, that is to say milled. Another way to generate threads is thread-forming, where the thread is pressed into the material of the workpiece by cold forming. Thread-forming for example is advantageous in the context of sheet metal working, because the accumulation of chips can be avoided thereby.

When processing many, especially large metal panels a large number of punchings and thread openings, frequently with varying dimensions and forms, must be produced. This requires a correspondingly high number of different punching- and thread-forming tools, which are used one after the other in short cycles. In order to be able to perform such sheet metal operations cost-efficiently, processing systems were developed, in which a plurality of tool receptacles are provided to be equipped with differently designed and/or dimensioned punching- or thread-forming tools and as necessary for processing the metal panels have to be used at places defined for these. Re-tooling the production lines for processing a metal panel can be avoided as a result or at least reduced.

Furthermore there are known tool units, which integrate a plurality of (different) thread-forming tools and are combined with a drive unit, which induces the linear and/or rotary movements of a respective one selected from the thread-forming tools. Such tool receptacles are advantageous in that the various thread-forming tools are operated by means of a single common drive unit.

Based on this prior art the objective of the invention was to indicate a possibility of further improving the formation of threads in a workpiece, especially also in the context of different processing (especially punching) of the workpiece.

This objective is achieved by a device according to patent claim 1. A production line comprising such a device is the subject matter of patent claim 15. Advantageous embodiments of the inventive device are the subject matter of the dependent patent claims and result from the following description of the invention.

The invention is based on the concept of designing a device for forming a thread in a workpiece, which has a plurality of tool receptacles for possible mounting of various thread-forming tools, as a unit which is as autonomous as possible and besides can be integrated as simply as possible into a processing system for the workpiece. Thus as flexible as possible an adaptation of the processing system to differently dimensioned threads to be formed in the workpiece is rendered possible.

Therefore such a device for forming a thread in a workpiece, which has at least one (single or multipart) housing and a plurality of tool receptacles which are rotatably or displaceably mounted in or on the housing for a (respective) thread-forming tool, according to the invention is characterized in that a linear drive, preferably a respective linear drive for each of the tool receptacles, and a rotary drive for the tool receptacles are also integrated into the housing.

By way of integrating a plurality of tool receptacles and drives provided for these into a coherent unit the simple possible integration aimed for by the invention and thus exchangeability of the device are reached, since attaching to or releasing the device from an external drive can be omitted when dismantling/assembling.

The “integration” of the linear drive(s) and the rotary drive into the housing means that forces on the housing, generated by the drives, are supported. The “integration” however does not presuppose that the (entire) drives must be placed within the housing, even though such an embodiment is preferably envisaged.

An inventive processing system, apart from such a device for forming a thread in a workpiece, also comprises at least one receptacle device designed to accommodate the device. A punch which can be moved by means of a drive is preferably provided. The punch can especially serve to move the device, in the case of a mobile and especially resilient support on the receptacle device, near to the workpiece intended for processing before one or more thread-forming tools is set-up.

In order to enable simple exchangeability, proposed by the invention, of the device in the production line, it is preferably proposed that the housing has integration means for detachable integration of the device in a receptacle device. The receptacle device of the processing system may comprise matching integration means corresponding to this.

Particularly simple exchangeability of the inventive device can be achieved, if the device is only inserted into the receptacle device, which enables tool-less dismantling/assembling of the device. For this purpose the integration means can have a bearing surface to support the weight of the device in its operating position and/or a contact surface to support a torque generated by the rotary drive.

In a preferred embodiment of the inventive device it may be proposed that the linear drive is designed to operate pneumatically and/or the rotary drive to operate electrically. This allows a particularly compact embodiment of the device. In addition, a rotary drive by electric motor is economically viable and a pneumatically operating working embodiment of the linear drive or the linear drives is distinguished by high motion speeds and high producible pressures for the tool receptacles and therefore the thread-forming tools held therein. This positively affects the cycle time which can be attained by the production line.

In a further preferred embodiment of the inventive device it may be proposed that the tool receptacles (and especially their axes of motion) are arranged evenly divided around a rotational axis of the rotary drive. This permits a particularly compact embodiment of the device and/or an advantageous embodiment of a gearbox, via which the rotation of an output shaft of the rotary drive can be transmitted to all the tool receptacles. For this purpose it may be especially proposed that the rotary drive turns a respective driving wheel for the tool receptacles via a central driven gear.

Further preferably it may then also be proposed that the driving wheels are non-rotationally connected to cylinder barrels of the tool receptacles, piston rods moving in the cylinder barrels, which in each case have one of the tool receptacles at an end located outside the associated cylinder barrel. Therefore the linear drives for the tool receptacles are configured in the form of pneumatic cylinders, which also comprise a respective driving wheel of the gearbox transmitting the rotary motion. This embodiment is again distinguished by its compactness. Furthermore as a result the number of components installed in the device is kept to a minimum, which can positively affect the cost, ease of assembly and maintenance and also reliability of the device.

Furthermore the cylinder barrels of the linear drives as a result can be achieved in the load path for transmitting the torque generated by the rotary drive on the thread-forming tools, for which reason torque-resistant running of the piston rods is then also necessary in a respective feed-through of the associated cylinder barrel, in order to transmit the torque of the cylinder barrels to the piston rods and the tool receptacles which are non-rotationally connected to these.

The driven and driving wheels of the rotary drive can be preferably designed in the form of gear wheels, because these permit slip-free transmission of a high torque. Other types of driven and driving wheels, for example in the form of friction wheels, are also feasible.

In a further preferred embodiment of the inventive device it may be proposed that the housing has a first housing part and a second housing part, the first housing part and the second housing part being connected together with relative mobility, whereby a relative motion of the housing parts leads to deformation of one or more spring elements. In this case it may be further preferably proposed that the first housing part comprises the tool receptacles and the second housing part has a contact area for contact of a punch in the production line. In the case of such a device it may be proposed that if the device moves on account of the punch in the production line near to the workpiece to be processed due to corresponding design of the spring stiffness only minor deformation of the spring element(s) occurs, while the spring element(s) are increasingly deformed, whenever the device contacts the workpiece and the punch, for example tolerance-related, continues to operate. The loads, which the punch for moving the device near to the workpiece exerts on the device, are therefore preferably absorbed by the housing and are not transmitted for example via the rotary drive, the spring-biased mobility of the two housing parts towards each other compensating too wide a travel of the punch and thus constitutes protection against overloading the housing.

In order to achieve as simple as possible an exchangeability of the inventive device it may be further preferably proposed that one or more plug-in connectors are provided for forming plug-in connectors with matching mating connectors of an energy supply for the linear drive and/or for the rotary drive. In this case the plug-in connectors can be designed so that they can be locked for example in the way of bayonet couplings. It may be particularly preferably proposed that a plug-in connector is provided for each of the linear drives and the rotary drive. Therefore each of the drives could be externally supplied separately with the necessary energy. This can offer the advantage that control of the respective linear drive can be put in place for using one of the several thread-forming tools by energising the associated power supply line and therefore by means of a central control unit in the production line. Therefore the integration of a corresponding control unit into the device may be dispensed with, as a result of which this can be designed simply and thus cost-efficiently and in particular compactly.

The indefinite article (“a” and “of a”), especially in the patent claims and in the description generally describing the patent claims, is to be understood as such and not as a number. Components accordingly made specific thereby are thus to be understood in such a way that these are present at least once and may be present several times.

The invention is described in detail below on the basis of an exemplary embodiment illustrated in the drawings, wherein

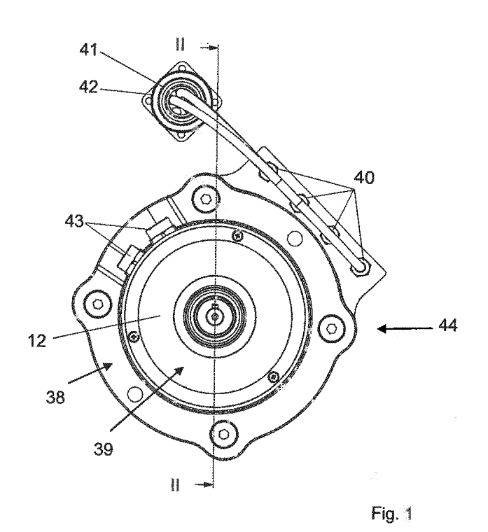

FIG. 1: shows an inventive device in a view from above;

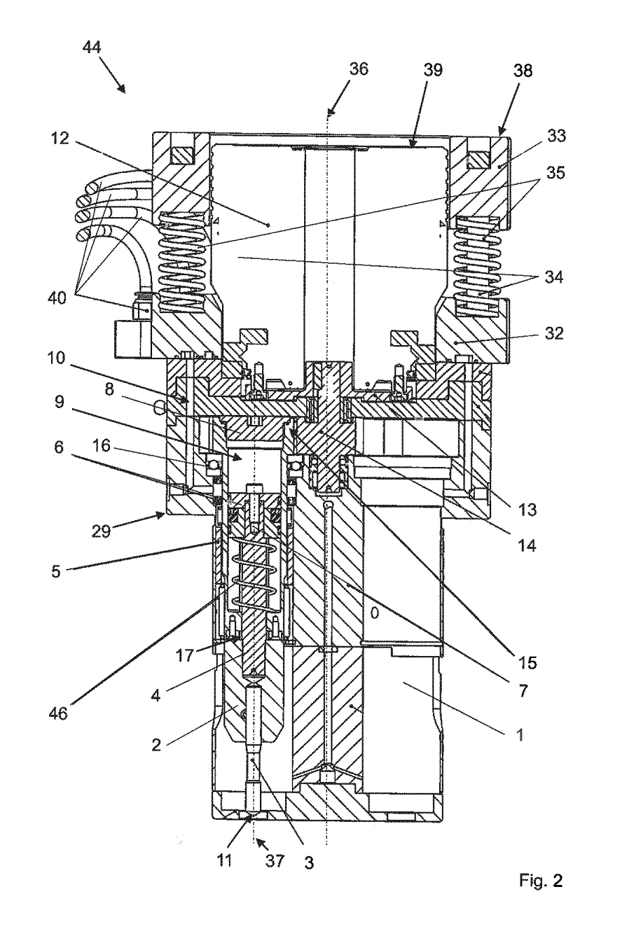

FIG. 2: shows the device in a profile along sectional plane II-II of FIG. 1; and

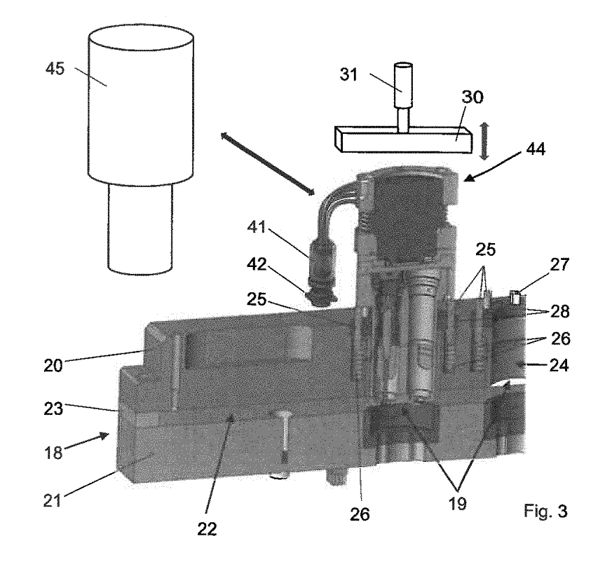

FIG. 3: shows a production line comprising the device in accordance with FIGS. 1 and 2.

The exemplary embodiment of an inventive device 44 for forming a thread in a workpiece (not shown), illustrated in the drawings, comprises a multipart housing, within which four accommodation spaces 1 in total are arranged for a respective tool receptacle 2 for a thread-generating tool in the form of a thread-forming tool 3 or a thread cutter. In FIGS. 2 and 3 a tool receptacle 2 is only arranged in the one of the two accommodation spaces 1 recognizable in the illustrated section.

This tool receptacle 2, in which a thread-forming tool 3 is held, is non-rotationally fastened to an end of a piston rod 4 of a pneumatic linear drive. This end of the piston rods 4 and thus the tool receptacle 2 are arranged in each position of the piston rod 4 outside a cylinder barrel 5 of the linear drive. At the distal end of the piston rods 4—in relation to the tool receptacle 2—a piston 6 is arranged, which runs in a sealed way inside the cylinder barrel 5. The multipart piston 6 and the piston rod 4 are connected together by a screw connection 7. On the side turned away from the tool receptacle 2 the piston 6 together with the adjacent section of the cylinder barrel 5 and cover 8 enclosing the cylinder barrel 5 on this side forms a pressure chamber 9, which can be filled with a pressurized gas, especially compressed air, via an associated pressure pipe 10 as a result of which the piston 6 together with the piston rod 4, the tool receptacle 2 and the thread-forming tool 3 held therein are driven towards an outlet 11 of the housing, so that the head of the thread-forming tool 3 is moved from the housing. The piston 6 and thus the thread-forming tool 3 are returned by means of a spring element 46. For simple fabrication the pressure pipes 10 are implemented in the form of drilled holes running in a straight line inside the housing.

Apart from a respective linear drive for each of the four tool receptacles 2, the device 44 also comprises a rotary drive with an electric motor 12, for example in the form of a direct current servo actuator, the rotor of which turns all four tool receptacles 2 at the same time via a power take-off flange 13 and a centrally driven gear wheel 14. For this purpose four driving gear wheels 15, which are integrated (in one piece) into the cylinder barrels 5, engage the driven gear wheel 14, as a result of which the cylinder barrels 5, which are rotatably mounted within the housing by means of roller bearings 16, can be turned by the electric motor 12. Such a rotation of a cylinder barrel 5 is transmitted via the piston rod 4 and the associated tool receptacle 2 to the corresponding thread-forming tool 3 and thus in combination with a movement induced by the linear drive permits a thread to form in a workpiece (sheet metal component) lying adjacent to the outlet 11. A torque can be transmitted between the cylinder barrel 5 and the piston rod 4 as a result of longitudinal gearing interlinking the piston rod 4 and a feed-through 17 of the cylinder barrel 5.

Such processing of a workpiece by means of the device 44 takes place on a production line, as shown in FIG. 3. The processing system comprises a receptacle device in the form of a tool bar 18, into which a plurality of receptacles 19 are integrated, which in each case can accommodate an inventive device 44 or another device for processing the workpiece with corresponding integration means. Especially punching machines 45 come into question as other devices for processing the workpiece. A combination of both one or more inventive devices 44 and one or more punching machines 45 permits a sheet metal component to be processed by punching and thread formation on the same production line.

The tool bar 18 is designed as a fork, i.e. it comprises a first bar 20 and a second bar 21, between which a receptacle slot 22 for the workpiece is formed. In this case the two bars 20, 21 are connected together only at one of their ends by a distance piece 23.

Each of the receptacles 19 comprises a passage 24 in the first bar 20, which serves to accommodate the outer side of a section of the housing of the device 44 as play-free as possible. Furthermore each of the receptacles 19 comprises a plurality of supporting bolts 25, resiliently mounted and arranged evenly divided around the passage 24. Springs 26 for the supporting bolts 25 are arranged in a respective blind drilled hole. These blind drilled holes at their open ends are enclosed by means of an annular bezel 28, in which the individual supporting bolts 25 are displaceably guided. The annular bezel 28 also has in addition a protrusion 27. In the case of the device 44 (or punching machine 45) integrated into a receptacle 19 the housing of the device 44 (or punching machine 45) with a bearing surface formed by an annular shoulder 29 of the housing rests on the outer lying front faces of the supporting bolts 25, as a result of which the weight of the device 44 (or punching machine 45) is supported. Furthermore the protrusion 27 of the annular bezel 28 then engages a matching recess (not shown) of the housing, a torque on the tool bar 18, generated by the electric motor 12, being supported.

In order to form a thread in a workpiece arranged within the receptacle slot 22 of the tool bar 18, the entire device 44 is first moved by means of a punch 30 only schematically suggested in FIG. 3 and an associated drive 31 in the production line within the passage 24 of the receptacle 19 and under increasing pre-bias of the springs 26 of the supporting bolts 25 towards the workpiece and thus at its lower end brought into contact with the workpiece. The forces transmitted thereby from the punch 30 to the device 44 are absorbed by the housing. In order to avoid overloading the housing and the components of the device 44 integrated therein, whenever the punch 30, although the device 44 already contacts the workpiece, is driven somewhat further, the housing has a first housing part 32, in which the tool receptacles 2, the linear drives and a section of the electric motor 12 are arranged, as well as a second housing part 33, which surrounds a further section of the electric motor 12. The first housing part 32 and the second housing part 33 are connected to one another with relative mobility by a plurality of guide screws 34 and spring elements 35 held on these. In this case this relative mobility is possible along an axis, which (approximately) corresponds to the rotational axis 36 of the electric motor 12. This rotational axis 36 of the electric motor 12 is arranged or aligned (approximately) coaxial to a longitudinal axis 36 of the device 44, (approximately) parallel to the movement axes 37 of the linear drives and coaxial or parallel to the movement axis of the punch 30. Whenever the device 44 is moved by means of the punch 30 towards the workpiece, the punch 30 pressing on a circular contact area 38 of the second housing part 33, the forces to be applied for this purpose, which substantially correspond to the sum of the resetting forces of the springs 26 of the supporting bolts 25, are so low that the spring elements 35 arranged between the housing parts 32, 33 are only slightly deformed. This changes as soon as the device 44 contacts the workpiece and the punch 30 is further operated. The forces then exerted by the punch 30 on the second housing part 33 then lead to continuing deformation of the spring elements 35, which as a result compensate too wide a travel of the punch 30 and prevent the housing being overloaded. The maximum deformation of the spring elements 35 to be expected in normal operation of the processing system is less than a projection of the contact area 38 of the housing in relation to an upper end face 39 of the electric motor 12, so that the electric motor 12 is not directly loaded by the punch 30.

Each of the linear drives of the device 44 is individually connected to an external compressed air- and therefore energy supply. This enables a selected linear drive to be controlled and therefore the associated thread-forming tool 3 to be used for forming a thread in the workpiece through an external control unit (not shown), which for this purpose releases the corresponding compressed air supply for the selected linear drive. This allows integration of a corresponding control unit into the device 44 itself to be dispensed with, as a result of which this can be designed with a relatively simple structure and therefore cost-efficiently.

Generally it is proposed at the same time not to use a plurality of the total four thread-forming tools 3 available by means of the device 44, which may have different diameters and/or thread forms. In fact for a thread to be formed next first the thread-forming tool 3 suitable for this is identified, then by corresponding displacement of the workpiece within the receptacle slot 22 of the tool bar 18 the place of the workpiece intended for the thread is positioned below the outlet 11 belonging to the identified thread-forming tool 3 and thereupon the corresponding linear drive and the rotary drive are activated, as a result of which the head of the thread-forming tool 3 penetrates the material of the workpiece and thus at the same time generates an opening and on the inside of the opening the intended thread by cold forming the material. All tool receptacles 2 and possibly thread-forming tools 3 held therein are turned by means of the rotary drive.

As a result of the proposed pluggable integration of the device 44 into the tool bar 18 the device 44 can be simply and quickly dismantled/assembled. This allows the tool bar 18 and therefore the production line to be equipped with one or more inventive devices 44 according to requirements. This may also be proposed in combination with punching machines 45, for which reason the punching machines 45 have matching integration means. Punching machines 45 thereby can be especially designed so that the stroke movements, with which their cuttings are made in the workpiece, are generated by the punch 30.

In order to guarantee particularly simple dismantling/assembly of the device 44 also with respect to the connections with the external energy sources, it is proposed to integrate all four pneumatic connections 40 of the housing into a combi plug-in connector 41 which comprises four individual plug-in connectors for the four pneumatic connections 40 and which must only be plugged together with a matching mating connector 42 of the compressed air supply and locked for example by a partial turn about the quick-release spindle. The electric motor 12 is likewise connected to a current source via two plug-in connectors 43, which are plugged together with matching mating connectors (not shown) of the electrical power supply.

### REFERENCE SYMBOL LIST

1 accommodation space
2 tool receptacle
3 thread-forming tool
4 piston rod
5 cylinder barrel
6 piston
7 screw connection
8 cover
9 pressure chamber
10 pressure pipe
11 outlet
12 electric motor
13 power take-off flange
14 driven gear wheel
15 driving gear wheel
16 roller bearing
17 feed-through
18 tool bar
19 receptacle
20 first bar
21 second bar
22 receptacle slot
23 distance piece
24 passage
25 supporting bolt
26 spring
27 protrusion
28 annular bezel
29 shoulder
30 punch
31 drive
32 first housing part
33 second housing part
34 guide screws
35 spring element
36 rotational axis of electric motor, longitudinal axis of device and movement axis of punch
37 movement axis of a linear drive
38 contact area
39 upper end face of the electric motor
40 pneumatic connection
41 plug-in connector of the pneumatic connection
42 mating connector
43 plug-in connector of the electric motor
44 device
45 punching machine
46 spring element

1. Device (44) for forming a thread in a workpiece having a housing and a plurality of tool receptacles (2) which are rotatably and displaceably mounted in or on the housing for a thread-forming tool, characterized in that a linear drive and a rotary drive for the tool receptacle(s) (2) are integrated into the housing.

2. Device (44) according to claim 1, characterized in that the housing has integration means for detachable integration of the device (44) into a receptacle device.

3. Device (44) according to claim 2, characterized in that the integration means comprise a bearing surface to support the weight of the device (44) in its operating position and/or a contact surface to support a torque generated by the rotary drive.

4. Device (44) according to claim 1, characterized in that the tool receptacles (2) are arranged evenly divided around a rotational axis (36) of the rotary drive.

5. Device (44) according to claim 1, characterized in that the linear drive is operated pneumatically and/or the rotary drive is operated electrically.

6. Device (44) according to claim 1, characterized in that the rotary drive turns a driving wheel for the tool receptacles (2) via a central driven gear in each case.

7. Device (44) according to claim 6, characterized in that the driving wheels are non-rotationally connected to cylinder barrels (5) of the tool receptacles (2), wherein piston rods (4) run in the cylinder barrels (5), which at one end located outside the associated cylinder barrel (5) have one of the tool receptacles (2) in each case.

8. Device (44) according to claim 7, characterized in that the piston rods (4) non-rotationally run in a feed-through (17) of the associated cylinder barrel (5) in each case.

9. Device (44) according to claim 1, characterized in that the housing has first housing part (32) and second housing part, wherein the first housing part (32) and the second housing part (33) are connected to one another with relative mobility, wherein a relative motion of the housing parts (32, 33) leads to deformation of one or more spring elements (35).

10. Device (44) according to claim 9, characterized in that the first housing part (32) encloses the tool receptacles (2) and the second housing part (33) has a contact area (38) for contact of a punch (30) in a production line.

11. Device (44) according to claim 1, characterized by one or more plug-in connectors (41, 42) for forming one or more plug-in connections with one or more mating connectors (43) of an energy supply for the linear drive and/or the rotary drive.

12. Device (44) according to claim 1, characterized by a linear drive for each of the respective tool receptacles (2).

13. Device (44) according to claim 11, characterized by a plug-in connector for each of the respective linear drives and the rotary drive.

14. Production line for a workpiece with a device (44) according to claim 1 and a receptacle device designed to accommodate the device (44).

15. Production line according to claim 14, characterized by a punch (30) which can be moved by means of a drive (31).
